(19) United States
(12) Patent Application Publication
(10) Pub. No.: US 2025/0122825 A1
(43) Pub. Date: Apr. 17, 2025

(54) TWO-PIECE SUN RACE FOR DRIVEN TURBOCHARGER

(71) Applicant: SuperTurbo Technologies, Inc., Loveland, CO (US)

(72) Inventors: Jared Howe, Loveland, CO (US); Jared William Brin, Loveland, CO (US)

(73) Assignee: SuperTurbo Technologies, Inc., Loveland, CO (US)

(21) Appl. No.: 18/829,600

(22) Filed: Sep. 10, 2024

Related U.S. Application Data
(60) Provisional application No. 63/543,620, filed on Oct. 11, 2023.

(51) Int. Cl. F02B 39/04; F02B 33/40; F02B 37/04

(52) U.S. Cl. CPC F02B 39/04; F02B 33/40; F02B 37/04

(57) ABSTRACT

Disclosed is a two-piece sun race precision fit onto the turbo shaft of a driven turbocharger with a traction drive that transmits torque to and from the turbo shaft. The turbo shaft is attached to a turbine and compressor and is inserted into a two-piece sun race that has traction surfaces to mate to the traction drive. This allows for simplification in manufacturing and assembly of the traction drive, as the two parts of the sun race can be simplified over a single-piece traction barrel and allow for greater flexibility in the design and assembly of the driven turbocharger than would be possible with a single-piece traction barrel.

### CROSS-REFERENCE TO RELATED APPLICATIONS

The present U.S. Utility patent application claims priority pursuant to 35 U.S.C. § 119(e) to U.S. Provisional Application No. 63/543,620, entitled, “TWO-PIECE SUN RACE FOR DRIVEN TURBOCHARGER,” filed on Oct. 11, 2023, which is incorporated herein by reference for all that it discloses and teaches and is made part of the present U.S. Utility Patent Application for all purposes.

### BACKGROUND

Driven turbochargers are an improvement over normal turbochargers since driven turbochargers (super-turbochargers) are powered by more than just the exhaust gas turbine, which reduces turbo-lag in boosted engines. Driven turbochargers can also direct excess turbine power back to the engine to increase engine efficiency. One class of driven turbocharger utilizes a traction drive that interfaces with the turbo shaft to provide torque to and from the turbo shaft.

### SUMMARY

An embodiment of the present invention may therefore comprise: a driven turbocharger for an engine system comprising: a turbo shaft; a compressor connected to a first location on the turbo shaft; a turbine connected to a second location on the turbo shaft; a two-piece sun race mounted on the turbo shaft comprising: a first sun race piece that mates with a shaft surface A of the turbo shaft via a precision fit; a second sun race piece that mates with a shaft surface B of the turbo shaft via a precision fit, wherein the shaft surface B of the turbo shaft is of larger diameter than the shaft surface A of the turbo shaft such that the second sun race piece clears the shaft surface A of the turbo shaft without interference during assembly; a traction drive in contact with a first race traction surface and a second race traction surface of the two-piece sun race that transfers torque to and from the turbo shaft.

An embodiment of the present invention may therefore further comprise: a method of assembling a rotating assembly for a driven turbocharger comprising: forming a shaft surface A and a shaft surface B on a turbo shaft wherein the shaft surface B of the turbo shaft is of larger diameter than the shaft surface A of the turbo shaft; inserting a second sun race piece of a two-piece sun race without interference over the shaft surface A of the turbo shaft; mating the second sun race piece of the two-piece sun race to the shaft surface B of the turbo shaft via a precision fit; mating a first sun race piece of the two-piece sun race to the shaft surface A of the turbo shaft via a precision fit.

### BRIEF DESCRIPTION OF THE DRAWINGS

FIG. 1A is an isometric view of a driven turbocharger with a traction drive.

FIG. 1B is an isometric view of a driven turbocharger with a traction drive with a two-piece sun race.

FIG. 2 is a cross-sectional view of a single piece traction barrel for a driven turbocharger that corresponds to the design in U.S. Pat. No. 10,539,159.

FIG. 3 is a cross-sectional view of a two-piece sun race mounted on a turbo shaft of a driven turbocharger.

FIG. 4 shows exploded views of a rotating assembly through the assembly process.

FIG. 5 shows a cross-sectional view of a rotating assembly with a two-piece sun race on a turbo shaft.

FIG. 6A shows a cross-sectional view of an alternative embodiment of a two-piece sun race of a rotating assembly.

FIG. 6B shows a cross-sectional view of an alternative embodiment of a two-piece sun race of a rotating assembly.

FIG. 7 shows a cross-sectional view of an alternative embodiment of a rotating assembly with the addition of a sleeve between a first sun race piece and a second sun race piece.

FIG. 8 shows a cross-sectional view of an alternative embodiment of a two-piece sun race where a first sun race piece and a second sun race piece are extended axially to mate with each other.

### DETAILED DESCRIPTION OF THE EMBODIMENTS

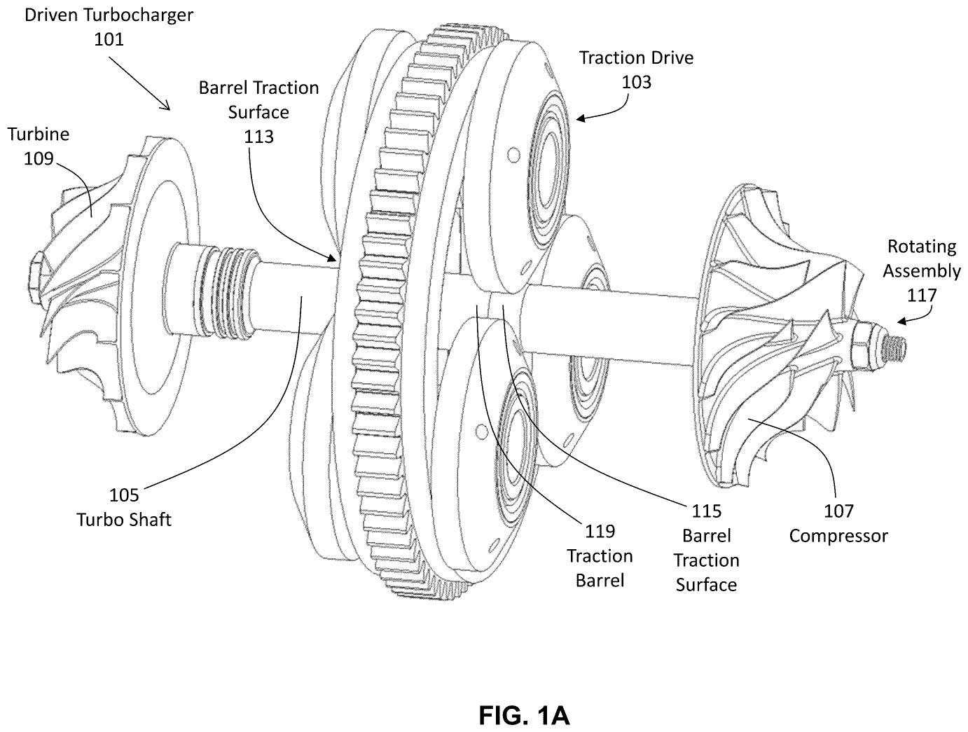

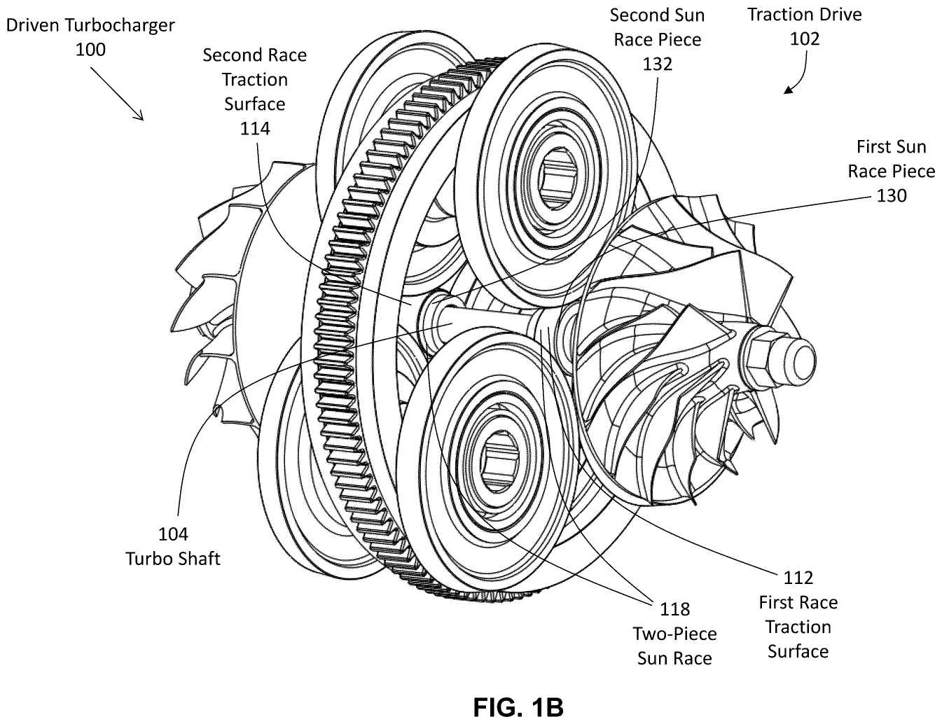

FIG. 1A is an isometric view of a driven turbocharger 101 with a traction drive 103. The driven turbocharger 101 corresponds to prior art from U.S. Pat. No. 10,539,159. Turbo shaft 105 has a compressor 107 and a turbine 109 connected to first and second locations on turbo shaft 105. The addition of traction drive 103 complicates the assembly of the driven turbocharger 101 since turbo shaft 105 additionally has traction surfaces, i.e., barrel traction surfaces 113, 115, that mate to traction drive 103. One way to simplify the parts and assembly of the driven turbocharger 101 is to have rotating assembly 117 comprised of turbo shaft 105, traction barrel 119, compressor 107 and turbine 109, in which traction barrel 119 has barrel traction surfaces 113, 115 that mate with traction drive 103. Separating out the parts of rotating assembly 117 allows for different materials to be used so that a material optimized for barrel traction surfaces 113, 115 can be used to manufacture traction barrel 119, and a different material can be used to manufacture turbo shaft 105. Having separate parts for rotating assembly 117 can also enable simplified individual parts that are easier and more economical to manufacture, as well as enabling greater design flexibility in general. The traction drive 103 can have various designs, as taught in U.S. Pat. No. 8,668,614, issued Mar. 11, 2014, entitled “High Torque Traction Drive,” U.S. Pat. No. 9,670,832, issued Jun. 6, 2017, entitled “Thrust Absorbing Planetary Traction Drive Superturbo,” U.S. Pat. No. 10,107,183, issued Oct. 23, 2018, entitled “Eccentric Planetary Traction Drive Super-Turbocharger,” and U.S. Pat. No. 10,539,159, issued Jan. 21, 2020, entitled “Two-Piece Shaft Assembly for Driven Turbocharger.” U.S. Pat. Nos. 8,668,614, 9,670,832, 10,107,183, and 10,539,159 are all specifically incorporated herein by reference for all that they disclose and teach.

FIG. 1B is an isometric view of a driven turbocharger 100 with a traction drive 102 having a two-piece sun race 118. The driven turbocharger 100 corresponds to the present invention. Instead of a single piece as in the prior art such as traction barrel 119 from FIG. 1A, two-piece sun race 118 is comprised of two parts, first sun race piece 130 and second sun race piece 132 that both mate to turbo shaft 104. Dividing two-piece sun race 118 into two separate pieces enables further flexibility and improvement in assembly of traction drive 102.

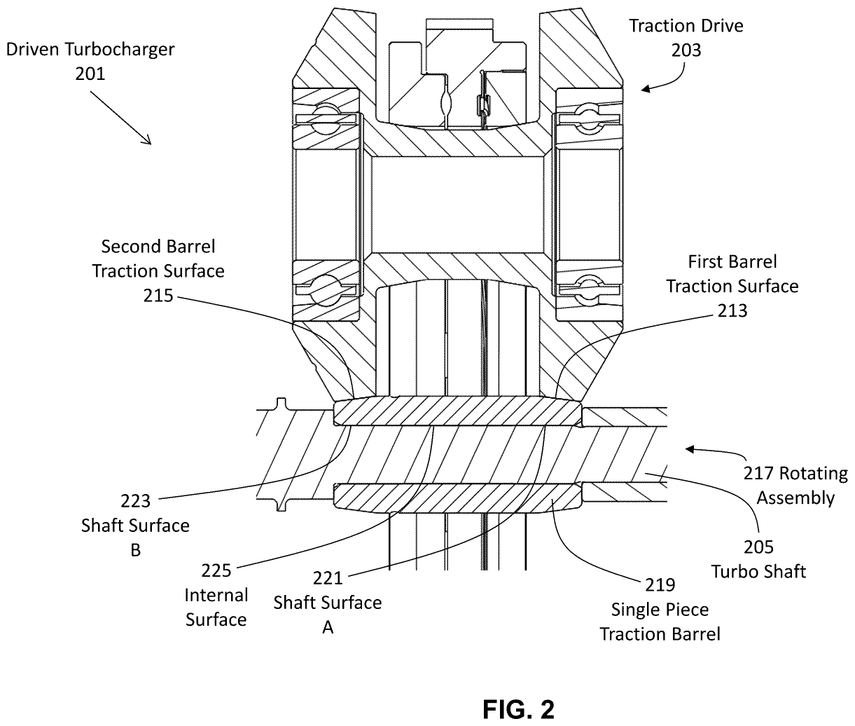

FIG. 2 is a cross-sectional view of a single piece traction barrel 219 for a driven turbocharger 201 that corresponds to the design in U.S. Pat. No. 10,539,159. This is a previous design, which has limitations that the new design of the present invention seeks to improve. Single piece traction barrel 219 is mounted on turbo shaft 205 via press fits at shaft surface A 221 and shaft surface B 223. For this previous design, single piece traction barrel 219 has a uniform diameter of internal surface 225, and similarly the diameters of shaft surface A 221 and shaft surface B 223 of turbo shaft 205 also have the same diameter as each other. The internal surface 225 of single piece traction barrel 219 is a precision machined surface along its entire length. Similarly, shaft surface A 221 and shaft surface B 223 of turbo shaft 205 are also precision machined surfaces to ensure precise fitting of single piece traction barrel 219 onto turbo shaft 205. As single piece traction barrel 219 is pressed onto turbo shaft 205, the internal surface 225 of single piece traction barrel 219 slides with interference over shaft surface A 221 for the entire length of single piece traction barrel 219 before pressing onto shaft surface B 223. This very long press fit over shaft surface A 221 of turbo shaft 205 can be problematic during assembly of driven turbocharger 201, causing excessively high press fit forces, and potentially causing galling or other damage of the shaft surface A 221 and/or internal surface 225 of single piece traction barrel 219. Additionally, as driven turbocharger 201 operates with very high rotational velocities of turbo shaft 205, it is beneficial for the rotational dynamics of rotating assembly 217 to separate first barrel traction surface 213 and second barrel traction surface 215 as far apart as possible on single piece traction barrel 219, and similarly to separate shaft surface A 221 and shaft surface B 223 on turbo shaft 205. The further apart first barrel traction surface 213 and second barrel traction surface 215 are, the more stable the rotational dynamics of the traction drive 203 and rotating assembly 217 are. Runout of the rotating assembly 217 is improved with greater separation of first barrel traction surface 213 and second barrel traction surface 215, and correspondingly increasing the separation of shaft surface A 221 and shaft surface B 223, which results in simplification of rotational balancing of the rotating assembly 217. However, increasing separation of first barrel traction surface 213 and second barrel traction surface 215, as well as shaft surface A 221 and shaft surface B 223, necessitates increasing the length of single piece traction barrel 219, and increasing the distance that internal surface 225 of single piece traction barrel 219 slides with interference over shaft surface A 221 during the press fit assembly of rotating assembly 217, increasing the chances of damage during assembly. Additionally, machining the precision diameter of internal surface 225 of single piece traction barrel 219 increases in difficulty and cost as the length of single piece traction barrel 219 increases.

To avoid the excessively long and forceful press fit of single piece traction barrel 219 over turbo shaft 205, it is beneficial to increase the diameter of shaft surface B 223 and the corresponding mating section of internal surface 225 of single piece traction barrel 219. This would greatly shorten the press fit distance on shaft surface A 221, but would require that the internal surface 225 of single piece traction barrel 219 have two different internal diameters along its length, increasing the manufacturing difficulty and cost of this component. It is extremely important that all of the mating surfaces of single piece traction barrel 219, including internal surface 225 as well as first barrel traction surface 213 and second barrel traction surface 215 are concentric and parallel, otherwise unbalanced rotation of rotating assembly 217 will occur. Introducing an additional, precision machined surface on the internal surface 225 of single piece traction barrel 219 complicates the manufacture of this part and reduces tolerancing accuracy.

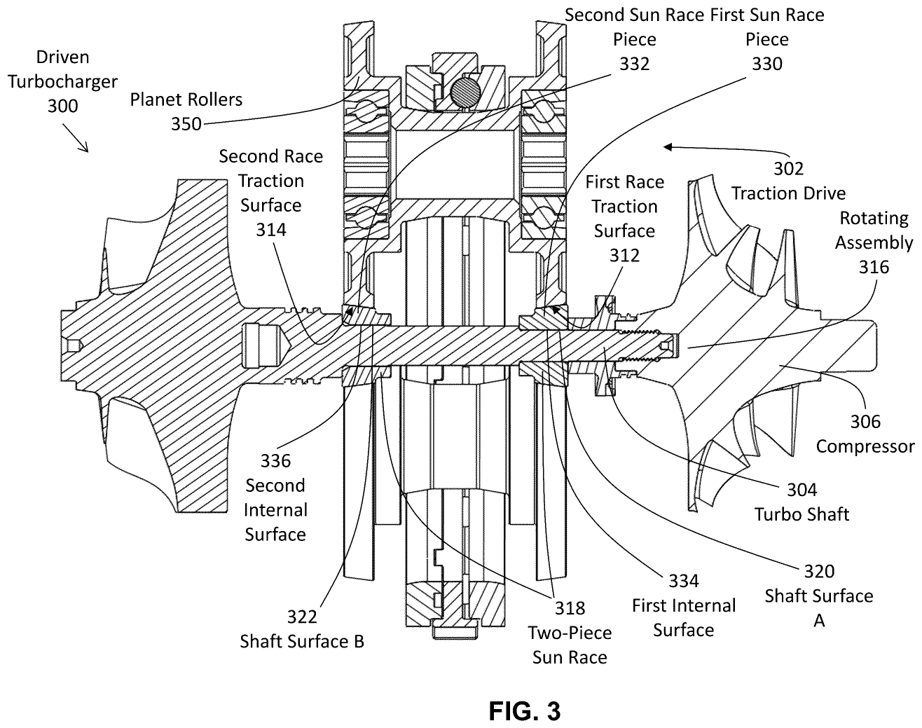

FIG. 3 is a cross-sectional view of a two-piece sun race 318 mounted on a turbo shaft 304 of a driven turbocharger 300. This updated design of the present invention enables more flexibility in the design and assembly of rotating assembly 316. Two-piece sun race 318 is comprised of first sun race piece 330 and second sun race piece 332. First sun race piece 330 has first race traction surface 312 formed on its exterior, and has a first internal surface 334 that mates with shaft surface A 320 of turbo shaft 304 via a precision fit. Second sun race piece 332 has a second race traction surface 314 formed on its exterior, and has a second internal surface 336 that mates with shaft surface B 322 of turbo shaft 304 via a precision fit. The precision fits of first sun race piece 330 and second sun race piece 332 on turbo shaft 304 may be press fits, slip fits, or transition fits. The diameter of shaft surface B 322 of turbo shaft 304 is of a larger diameter than shaft surface A 320 of turbo shaft 304, and, correspondingly, the diameter of second internal surface 336 of second sun race piece 332 is larger than the diameter of first internal surface 334 of first sun race piece 330. This allows for second sun race piece 332 to clear shaft surface A 320 of turbo shaft 304 without interference during assembly, before second sun race piece 332 is precision fit onto shaft surface B 322 of turbo shaft 304. This eliminates the excessively long press fit required by the previous design described in FIG. 2. As shown, first sun race piece 330 and second sun race piece 332 may be separate and not touching, or they may also be adjacent to each other with a mating surface between them as described in alternate embodiments in following figures. Additionally, each piece of two-piece sun race 318, first sun race piece 330 and second sun race piece 332, has only a single precision machined internal diameter, first internal surface 334 and second internal surface 336 respectively. This simplifies the manufacturing of first sun race piece 330 and second sun race piece 332 and allows for tighter tolerances on the precision machined surfaces. The precision machined surfaces of first internal surface 334 and second internal surface 336 can also be only as wide as necessary to precision fit mate to shaft surface A 320 and shaft surface B 322 respectively, instead of having a precision machined surface that is the full length of two-piece sun race 318 as in the previous design from FIG. 2. Traction drive 302 contacts first race traction surface 312 and second race traction surface 314 of two-piece sun race 318 and transfers torque to and from two-piece sun race 318 and turbo shaft 304. Additionally, first race traction surface 312 and second race traction surface 314 may be shaped as shown such that thrust forces on turbo shaft 304 are absorbed by traction drive 302, as taught in U.S. Pat. No. 9,670,832, issued Jun. 6, 2017, entitled “Thrust Absorbing Planetary Traction Drive Superturbo,” which is specifically incorporated herein by reference for all that it discloses and teaches. As shown, first race traction surface 312 on first sun race piece 330 may be angled inwardly away from compressor 306, which allows for an assembly process where first sun race piece 330 is installed on said turbo shaft 304 after planet rollers 350 of traction drive 302 of driven turbocharger 300 are arranged around turbo shaft 304 during assembly of traction drive 302. This enables a simpler, easier assembly process of traction drive 302.

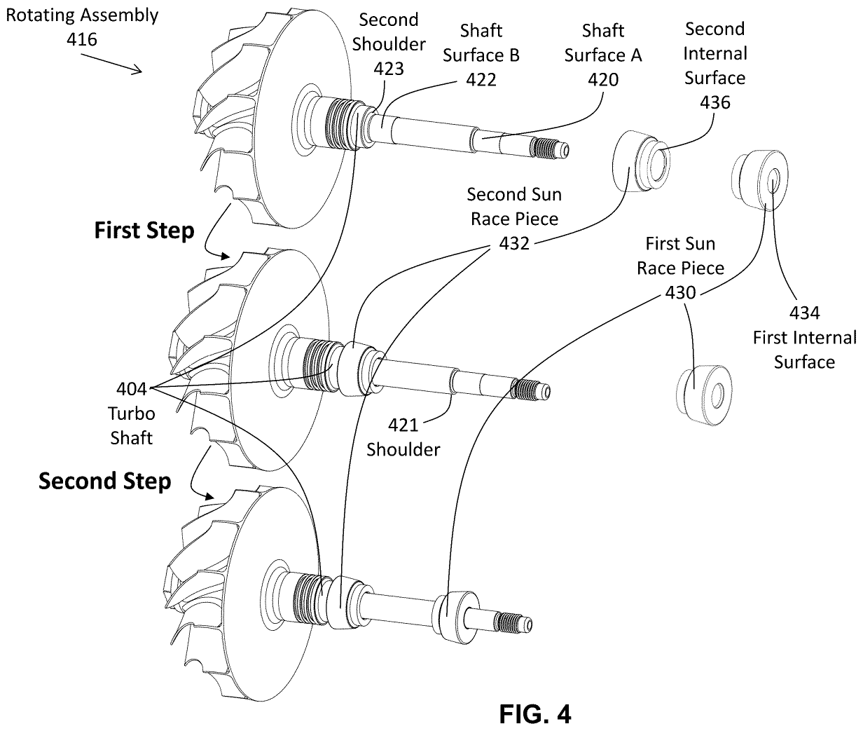

FIG. 4 shows exploded views of a rotating assembly 416 through the assembly process. Shaft surface A 420 and shaft surface B 422 are formed on turbo shaft 404, and shaft surface B 422 is of larger diameter than shaft surface A 420. As a first step, second sun race piece 432 is inserted, without interference, over and past shaft surface A 420 of turbo shaft 404. As the internal diameter of second internal surface 436 of second sun race piece 432 is larger than the diameter of shaft surface A 420 of turbo shaft 404, second sun race piece 432 does not contact turbo shaft 404 with interference until it reaches shaft surface B 422. Second sun race piece 432 is precision fit onto turbo shaft 404, with second internal surface 436 mating in the precision fit with shaft surface B 422. Unlike in the previous design shown in FIG. 2, second internal surface 436 only has a short distance of precision fit onto shaft surface B 422, as it does not contact the smaller diameter of shaft surface A 420 with interference. An optional intermediate step following the first step is to assemble the traction drive 302 from FIG. 3 around turbo shaft 404 before proceeding. Once second sun race piece 432 is precision fit onto turbo shaft 404, the second assembly step is that first sun race piece 430 is inserted over turbo shaft 404, and precision fit onto shaft surface A 420 of turbo shaft 404. First internal surface 434 of first sun race piece 430 mates with shaft surface A 420 in this precision fit. The precision machined first internal surface A 434 can be made to only be long enough for the precision fit onto shaft surface A 420, so that the excessive interference sliding of the previous design from FIG. 2 on shaft surface A 420 is avoided. Additionally, as shown, a shoulder 421 may be formed on turbo shaft 404 to locate first sun race piece 430 axially on turbo shaft 404. A second shoulder 423 may also be formed on turbo shaft 404 to locate second sun race piece 432 axially on turbo shaft 404 as well.

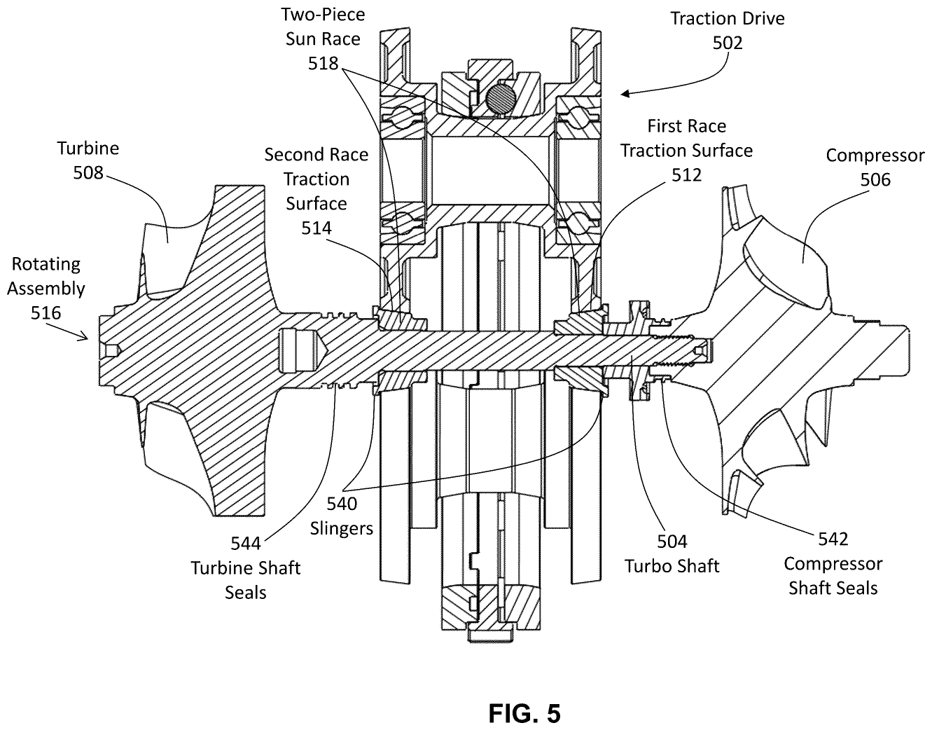

FIG. 5 shows a cross-sectional view of a rotating assembly 516 with a two-piece sun race 518 on a turbo shaft 504. Shown on two-piece sun race 518 are optional slingers 540, located on the outer edges of two-piece sun race 518, adjacent to first race traction surface 512 and second race traction surface 514. These slingers 540 can help remove traction fluid from the rotating assembly 516 once it has left first race traction surface 512 and second race traction surface 514. Traction fluid is used in traction drive 502 to increase the torque capacity of traction drive 502, as well as for lubrication, cooling, and to prevent damage to traction drive 502. However, the traction fluid should not travel down turbo shaft 504 to either compressor 506 or turbine 508, as it needs to stay contained. Slingers 540 help to remove traction fluid from rotating assembly 516, before it reaches compressor shaft seals 542 and turbine shaft seals 544.

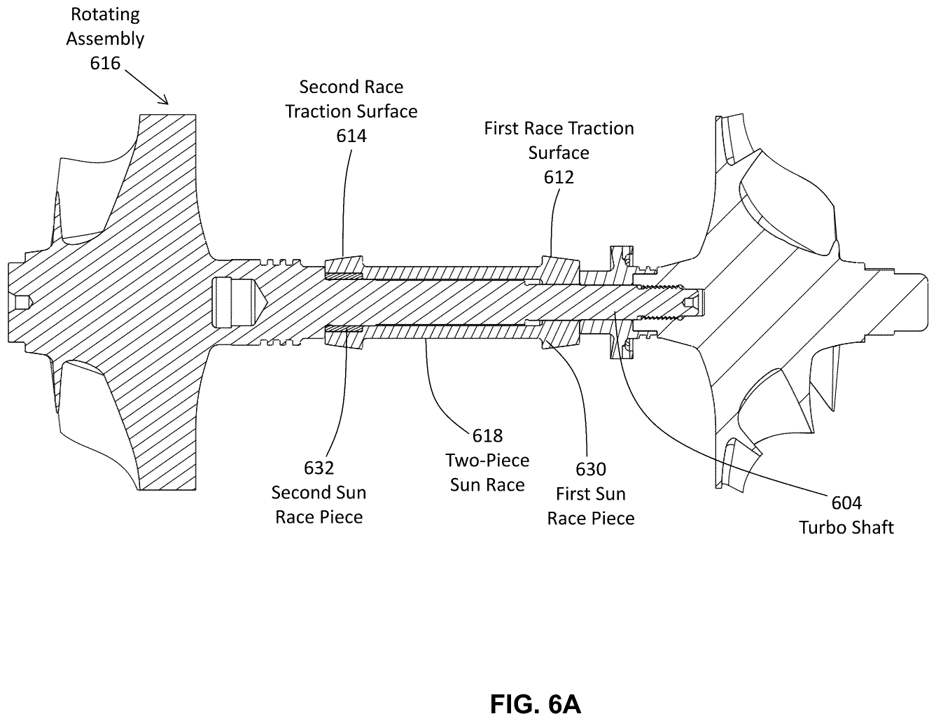

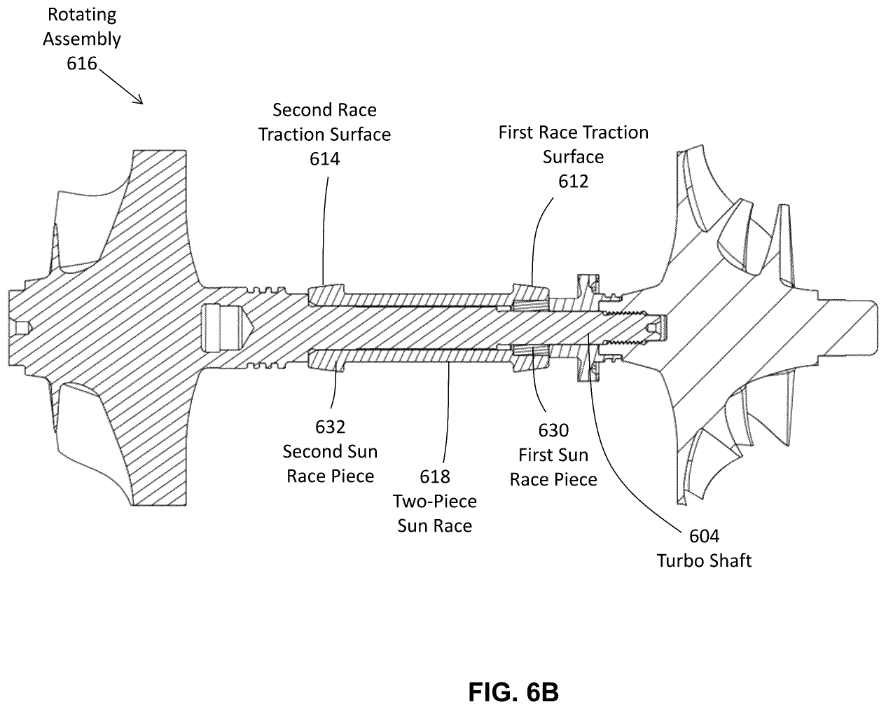

FIG. 6A shows a cross-sectional view of an alternative embodiment of a two-piece sun race 618 of a rotating assembly 616. In this embodiment, both first race traction surface 612 and second race traction surface 614 are formed on first sun race piece 630. Second sun race piece 632 is precision fit onto turbo shaft 604, and also mates to first sun race piece 630. First sun race piece 630 is also precision fit onto turbo shaft 604.

FIG. 6B shows a cross-sectional view of an alternative embodiment of a two-piece sun race 618 of a rotating assembly 616. In this embodiment, both first race traction surface 612 and second race traction surface 614 are formed on second sun race piece 632. First sun race piece 630 is precision fit onto turbo shaft 604, and also mates to second sun race piece 632. Second sun race piece 632 is also precision fit onto turbo shaft 604.

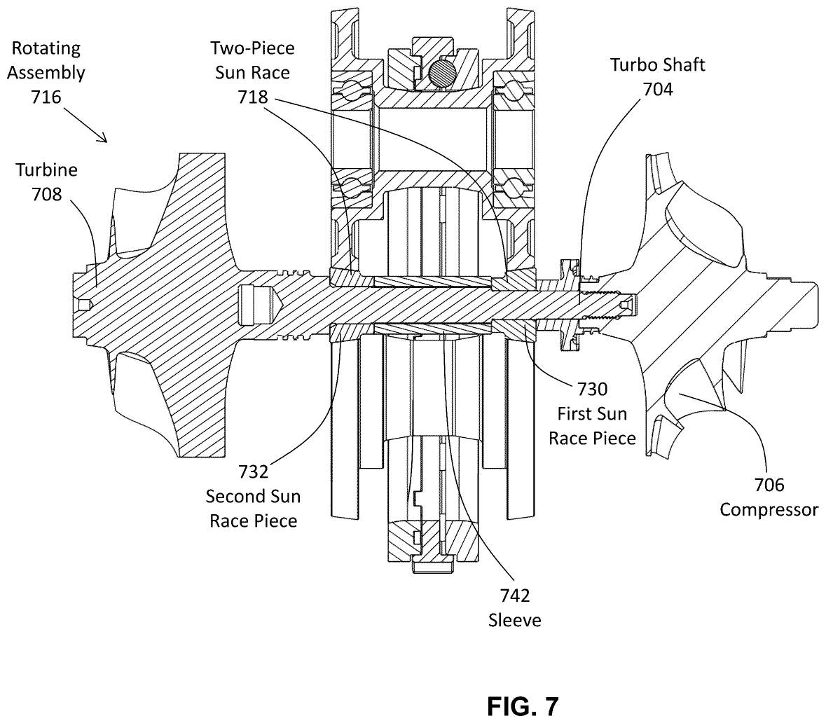

FIG. 7 shows a cross-sectional view of an alternative embodiment of a rotating assembly 716 with the addition of a sleeve 742 between a first sun race piece 730 and a second sun race piece 732. The addition of sleeve 742 would increase the stiffness of the rotating assembly 716, as it would have a similar effect as increasing the diameter of turbo shaft 704. Sleeve 742 could utilize different thicknesses and dimensions to optimize this stiffness, in order to adjust and tune the rotodynamic characteristics of rotating assembly 716. Increasing the stiffness of rotating assembly 716 may be useful for applications using a large, high mass and high inertia turbine 708 and/or compressor 706. The ability to add a sleeve 742 located between first sun race piece 730 and second sun race piece 732 that increases the effective stiffness of turbo shaft 704 without changing the dimensions of turbo shaft 704 is an additional benefit of the two-piece sun race 718.

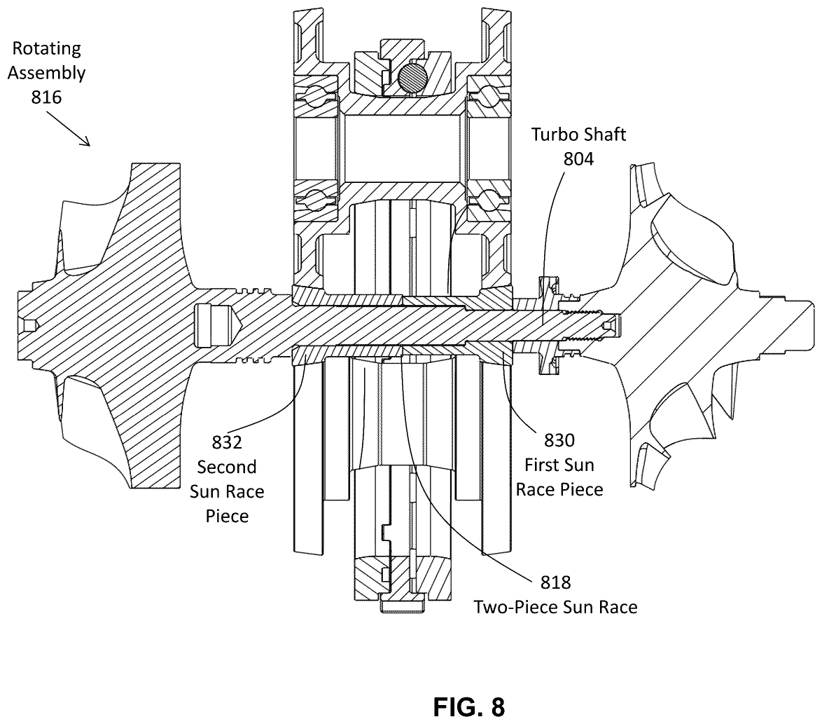

FIG. 8 shows a cross-sectional view of an alternative embodiment of a two-piece sun race 818 where a first sun race piece 830 and a second sun race piece 832 are extended axially to mate with each other. Extending first sun race piece 830 and second sun race piece 832 axially so that they mate has a similar effect as the addition of the sleeve 742 from FIG. 7 to increase the stiffness of rotating assembly 816, without changing the dimensions or increasing the diameter of turbo shaft 804. Again, different thicknesses and geometries of the axial extensions of first sun race piece 830 and second sun race piece 832 can be used to tune, adjust, and optimize the rotodynamic characteristics of rotating assembly 816. Mating first sun race piece 830 and second sun race piece 832 of two-piece sun race 818 by axially extending first sun race piece 830 and second sun race piece 832 in order to increase the effective stiffness of turbo shaft 804 is an alternative way to achieve the desired stiffness of rotating assembly 816 without changing the dimensions of turbo shaft 804.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A driven turbocharger for an engine system comprising:
a turbo shaft;
a compressor connected to a first location on said turbo shaft;
a turbine connected to a second location on said turbo shaft;
a two-piece sun race mounted on said turbo shaft comprising:
a first sun race piece that mates with a shaft surface A of said turbo shaft via a precision fit;
a second sun race piece that mates with a shaft surface B of said turbo shaft via a precision fit, wherein said shaft surface B of said turbo shaft is of larger diameter than said shaft surface A of said turbo shaft such that said second sun race piece clears said shaft surface A of said turbo shaft without interference during assembly;
a traction drive in contact with a first race traction surface and a second race traction surface of said two-piece sun race that transfers torque to and from said turbo shaft.

2. The driven turbocharger of claim 1 where said first race traction surface is formed on said first sun race piece and said second race traction surface is formed on said second sun race piece.

3. The driven turbocharger of claim 1 where said first race traction surface and said second race traction surface are formed on said first sun race piece.

4. The driven turbocharger of claim 1 where said first race traction surface and said second race traction surface are formed on said second sun race piece.

5. The driven turbocharger of claim 1 where said first race traction surface and said second race traction surface are shaped such that thrust forces on said turbo shaft are absorbed by said traction drive.

6. The driven turbocharger of claim 1 further comprising a slinger formed adjacent to said first race traction surface.

7. The driven turbocharger of claim 1 further comprising a slinger formed adjacent to said second race traction surface.

8. The driven turbocharger of claim 1 further comprising a shoulder formed on said turbo shaft that locates said first sun race piece axially on said turbo shaft.

9. The driven turbocharger of claim 1 further comprising a second shoulder formed on said turbo shaft that locates said second sun race piece axially on said turbo shaft.

10. The driven turbocharger of claim 2 wherein said first race traction surface on said first sun race piece is angled inwardly away from said compressor.

11. The driven turbocharger of claim 1 further comprising a sleeve located between said first sun race piece and said second sun race piece that increases the effective stiffness of said turbo shaft.

12. A method of assembling a rotating assembly for a driven turbocharger comprising:
forming a shaft surface A and a shaft surface B on a turbo shaft wherein said shaft surface B of said turbo shaft is of larger diameter than said shaft surface A of said turbo shaft;
inserting a second sun race piece of a two-piece sun race without interference over said shaft surface A of said turbo shaft;
mating said second sun race piece of said two-piece sun race to said shaft surface B of said turbo shaft via a precision fit;
mating a first sun race piece of said two-piece sun race to said shaft surface A of said turbo shaft via a precision fit.

13. The method of claim 12 further comprising:
forming a first race traction surface on said first sun race piece;
forming a second race traction surface on said second sun race piece;
mating a traction drive to said first race traction surface and said second race traction surface.

14. The method of claim 12 further comprising:
forming a first race traction surface and a second race traction surface on said first sun race piece;
mating a traction drive to said first race traction surface and said second race traction surface.

15. The method of claim 12 further comprising:
forming a first race traction surface and a second race traction surface on said second sun race piece;
mating a traction drive to said first race traction surface and said second race traction surface.

16. The method of claim 13 wherein said first race traction surface and said second race traction surface are shaped such that thrust forces on said turbo shaft are absorbed by said traction drive.

17. The method of claim 13 further comprising:
forming a slinger adjacent to said first race traction surface.

18. The method of claim 13 further comprising:
forming a slinger adjacent to said second race traction surface.

19. The method of claim 14 wherein said first race traction surface and said second race traction surface are shaped such that thrust forces on said turbo shaft are absorbed by said traction drive.

20. The method of claim 14 further comprising:
forming a slinger adjacent to said first race traction surface.

21. The method of claim 14 further comprising:
forming a slinger adjacent to said second race traction surface.

22. The method of claim 15 wherein said first race traction surface and said second race traction surface are shaped such that thrust forces on said turbo shaft are absorbed by said traction drive.

23. The method of claim 15 further comprising:
forming a slinger adjacent to said first race traction surface.

24. The method of claim 15 further comprising:
forming a slinger adjacent to said second race traction surface.

25. The method of claim 12 further comprising forming a shoulder on said turbo shaft that locates said first sun race piece.

26. The method of claim 12 further comprising forming a second shoulder on said turbo shaft that locates said second sun race piece.

27. The method of claim 13 wherein said first sun race piece is installed on said turbo shaft after planet rollers of a traction drive of said driven turbocharger are arranged around said turbo shaft during assembly of said traction drive.

28. The method of claim 12 further comprising mating said first sun race piece and said second sun race piece of said two-piece sun race by axially extending said first sun race piece and said second sun race piece in order to increase the effective stiffness of said turbo shaft.
